(19) United States
(12) Patent Application Publication
(10) Pub. No.: US 2011/0212677 A1
(43) Pub. Date: Sep. 1, 2011

(54) HOUSING ASSEMBLY FOR AN ELECTRICAL DEVICE

(75) Inventor: Kevin Allan Dooley, Mississauga (CA)

(73) Assignee: PRATT & WHITNEY CANADA CORP., Longueuil (CA)

(21) Appl. No.: 12/713,545

(22) Filed: Feb. 26, 2010

(51) Int. Cl. B64D 13/00

(52) U.S. Cl. 454/74

(57) ABSTRACT

A housing assembly for an electrical device for use on an aircraft is provided. The assembly comprises a housing configured for containing at least one electrical component in a portion of the aircraft vented to atmosphere; and a pressure communication line for communicating between an interior of the housing and a source of pressurized gas available on the aircraft for other primary purpose.

### TECHNICAL FIELD

The disclosure relates generally to housings for electrical devices and more particularly to maintaining environmental conditions inside such housings.

### BACKGROUND OF THE ART

Electrical devices mounted external to a pressurized passenger cabin of an aircraft must be properly housed to ensure reliable operation. Variations in atmospheric conditions seen during different phases of flight of the aircraft may have adverse effects on electrical devices. For example, low atmospheric pressures experienced at high altitude can increase the potential for corona discharge or arcing in electrical devices such as high voltage engine-mounted power systems.

Sealed housings have been used to enclose such electrical devices mounted external to a pressurized passenger cabin of an aircraft. However, such housings are typically expensive to make and use, since they must be sufficiently pressure-tight to withstand variations in atmospheric conditions seen during different phases of flight of the aircraft, including those at high altitude and very low pressures. Also, in the event of a leak in a sealed housing, no solution is provided to maintain suitable environmental conditions for electrical devices inside the housing, with consequent failures due to arcing, corona discharge, etc.

Improvement in maintaining environmental conditions inside housings for electrical devices is therefore desirable.

### SUMMARY

The disclosure describes housings for electrical devices and methods for maintaining environmental conditions inside such housings.

Thus, in one aspect, the disclosure provides a housing assembly for an electrical device for use on an aircraft. The assembly comprises: a housing configured for containing at least one electrical component in a portion of the aircraft vented to atmosphere; and a pressure communication line for communicating between an interior of the housing and a source of pressurized gas available on the aircraft for other primary purpose.

In another aspect, the disclosure provides a gas turbine engine assembly for use on an aircraft. The gas turbine engine assembly comprises: a gas turbine engine; a housing mounted on the gas turbine engine and configured for containing at least one component of an electrical system of the engine; and a pressure communication line for communicating between an interior of the housing and a source of pressurized gas available on the aircraft for other primary purpose.

In another aspect, the disclosure provides a method for maintaining an environment inside a housing for an electrical device, the housing being located in a portion of an aircraft vented to atmosphere. The method comprises: providing the housing with a flow of top-up air from a source of pressurized air available on the aircraft for other primary purpose.

In a further aspect, the disclosure provides a housing assembly for an electrical device for use on an aircraft. The assembly comprises: a housing configured for containing at least one electrical component in a portion of the aircraft vented to atmosphere; and means for communicating between an interior of the housing and a source of pressurized gas available on the aircraft for other primary purpose.

Further details of these and other aspects of the subject matter of this application will be apparent from the detailed description and drawings included below.

### DESCRIPTION OF THE DRAWINGS

Reference is now made to the accompanying drawings, in which:

FIG. 1 shows a schematic representation of an embodiment of a housing assembly for an electrical device in accordance with the disclosure;

FIG. 2 shows a schematic partial transverse cross-section view of an aircraft comprising a housing assembly in accordance with the disclosure; and

FIG. 3 shows the axial cross-section view of the turbine engine of FIG. 1 including a housing assembly in accordance with the disclosure.

### DETAILED DESCRIPTION OF THE PREFERRED EMBODIMENTS

Various aspects of preferred embodiments are described through reference to the drawings.

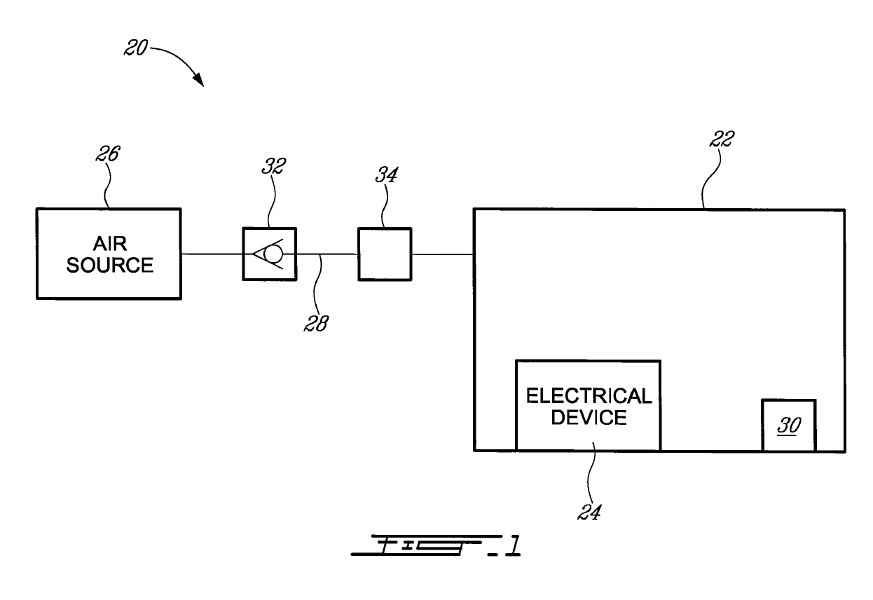

FIG. 1 illustrates an embodiment of a housing assembly 20 in accordance with the disclosure. In the embodiment shown, housing assembly 20 comprises housing 22 for containing and protecting one or more electrical device(s) or circuit(s) 24, and one or more independent source(s) of pressurized air, or other gas(ses), 26, which may for example be used to provide top-up air, nitrogen, or other preferably inert gas to housing 22 in the event of a leak or other undesirably-low pressure situation. Housing 22 is in fluid communication with source of pressurized air 26 by means of tube, pipe, channel, or other conduit or line 28. Housing assembly 20 may further comprise any or all of internal air or other gas drying device, or desiccator, 30, check valve or other flow control device 32, and/or external moisture removal device, or desiccator, 34. Other suitable air conditioning equipment (not shown) may also be provided, depending on the source and nature of pressurized gas 26 that is used, and the environmental requirements for the inside of housing 22, which may be driven by, for example, characteristics of housed electrical device(s) or circuit(s) 24. Internal desiccator 30 may comprise a suitable chemical or other desiccant substance (not shown) provided inside housing 22 for absorbing moisture inside housing 22. Flow control device 32 include one or more check valves or other devices for preventing back-flow from housing 22 through conduit 28. External moisture removal device 34 may comprise conventional or other moisture removal membrane(s) (not shown) for removing at least a portion of the moisture from top-up air entering housing 22.

Independent pressure source(s) 26 may comprise any sources of air or other gas(ses) available on the aircraft for a primary purpose(s) other than maintaining fluid pressure within housing 22. For example, source(s) 26 may include a pressurized passenger cabin or compartment, or a source of pressurized gas provided for such cabin or compartment, a bleed air duct from a compressor or other portion of a primary propulsion or auxiliary power turbine on an aircraft, an unrelated pneumatic system (such as a tire inflation system, or door or panel control system), etc. Among the several advantages offered by the disclosure herein are the reduced cost and weight associated with use of air or other gas(ses) pressurized by such sources other than dedicated pumps, etc., provided specifically for pressuring housing 22.

Another of the advantages offered by the disclosure is that in many applications housing 22 need not be perfectly sealed. As will be understood by those skilled in the relevant arts, the provision and maintenance of perfectly-sealed, or nearly perfectly-sealed housings can be expensive. By providing fluid communications line(s) 28 to communicate air or other gas(ses) already pressurized for other purposes to top-up a partial pressure within a partially-sealed housing 22, the invention offers advantages of reduced weight, cost, and complexity over prior art alternatives.

As will be understood by those skilled in the relevant arts, the amount, or effectiveness, of partial pressure sealing of a housing 22 will depend upon factors such as the type(s) and requirements of circuit(s) or device(s) 24 protected by the housing, and the operating condition of the aircraft or engines on which they are to be installed. Such operating conditions can include the altitude(s) at which such an aircraft is to be operated, and the pressures, temperatures, humidities, etc., to be encountered by the device(s) or circuit(s) 24 and the housing 22. As an example, it has been determined that housings which can withstand internal/external pressure differentials of approximately 12 psi, in conjunction with top-up air line(s) 28, can be advantageously used in implementing the systems and methods disclosed herein.

Use of check valve(s) or other flow control device(s) 32 can eliminate the need for provision of monitoring circuits or devices within the housing 22.

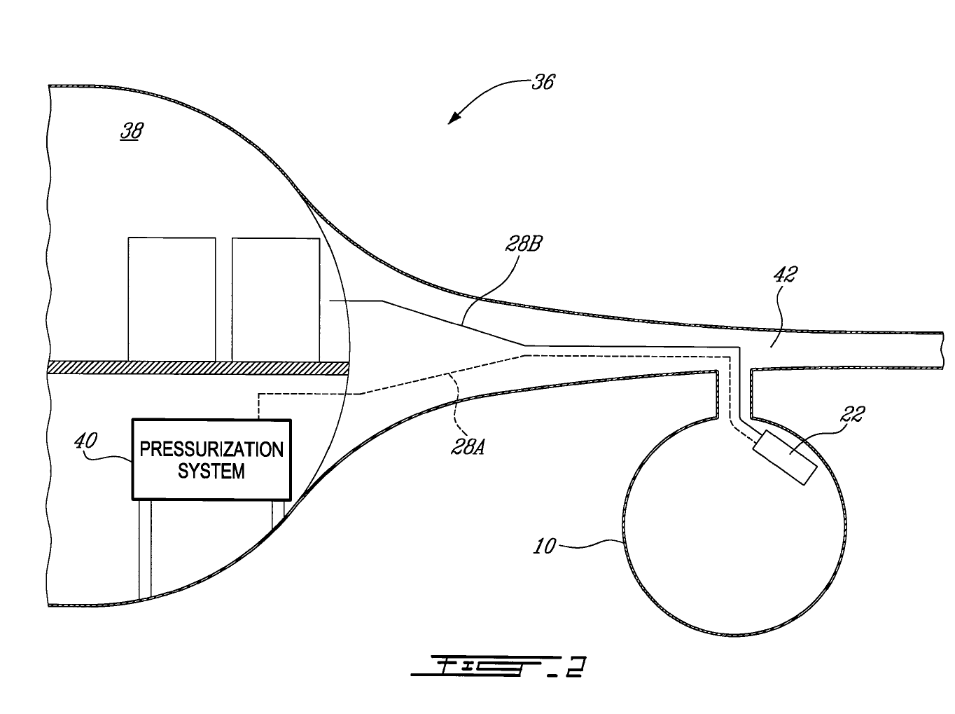

FIG. 2 illustrates a schematic representation of a housing assembly 20 in accordance with the disclosure installed on an aircraft 36. In the embodiment shown, aircraft 36 comprises passenger cabin 38, cabin pressurization system 40, wing portion 42 and engine 10 secured to wing portion 42. Housing(s) 22 may be installed in a portion of an aircraft 36 that is external to passenger cabin 38 (i.e. vented to the atmosphere) and therefore be exposed to variations in atmospheric pressure throughout different phases of flight. In the exemplary embodiment shown, housing 22 may be mounted to or in the vicinity of engine 10 in a conventional manner known in the art.

As will be appreciated by those skilled in the relevant arts, once they have been made familiar with this disclosure, any reliable and otherwise suitable source of pressurized air available onboard aircraft 36 may be used for supplying top-up air to housing 22. As noted, source(s) 26 of pressurized air may comprise any existing source(s) of pressurized air already onboard an aircraft 36 that is typically used for another purpose during normal operation of aircraft 36, including for example a passenger cabin or cabin environmental control system. Accordingly, housing 22 may be in fluid communication with cabin pressurization system 40 via conduit 28A, or, housing 22 may be in fluid communication with passenger cabin 38 via conduit 28B. Advantageously, top-up air obtained from either cabin pressurization system 40 or passenger cabin 38 may already be at a suitable pressure, temperature, sufficiently dry and clean to be supplied to housing 22 without further conditioning.

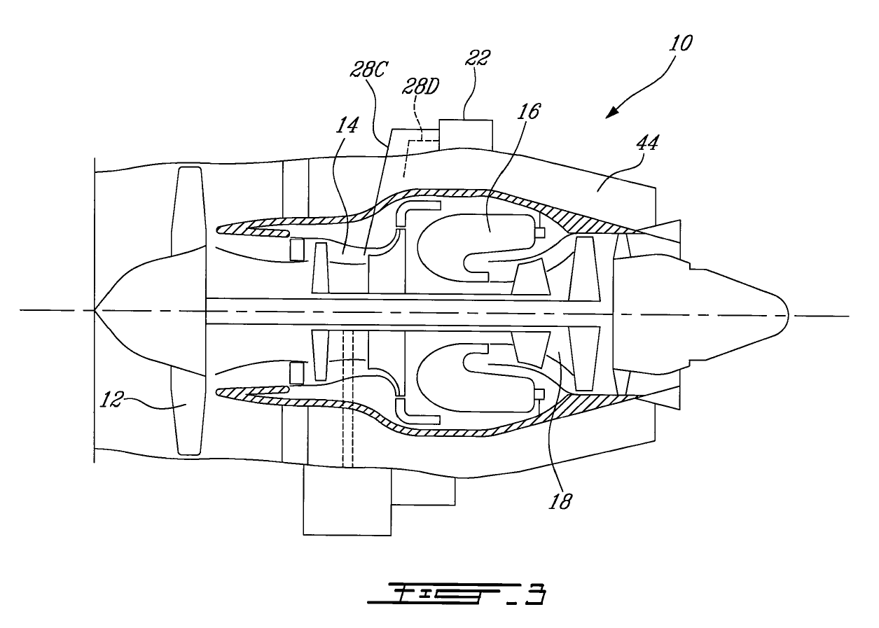

FIG. 3 illustrates, as an example of an environment suitable for implementation of the material disclosed herein, an engine 10 on which a housing 22 has been installed. In the embodiment shown, engine 10 is a gas turbine of a type commonly provided for use in subsonic flight, generally comprising in serial flow communication a fan 12 through which ambient air is propelled, a multistage compressor 14 for pressurizing air passed by fan 12 to the core of the engine 10, a combustor 16 in which compressed air is mixed with fuel and ignited for generating an annular stream of hot combustion gases, and a turbine section 18 for extracting energy from the heated combustion gases.

In such embodiments top-up air or other gas(ses) may be obtained from engine 10. As such, source(s) 26 of pressurized air may include compressor(s) 14 and/or bypass duct(s) 44 of engine 10. Housing(s) 22 may be in fluid communication with compressor 14 via, for example, conduit(s) 28C, or housing 22 with bypass duct 44 via conduit 28D. It will be appreciated by those skilled in the relevant arts that top-up air or other gas(ses) provided compressor 14 or bypass duct 44 may require conditioning to regulate pressure, temperature, moisture content, contaminants, etc., prior to entering housing 22. For example, flow control device(s) 32, water removal device(s) 34 and other air conditioning equipment may be required.

It will also be appreciated that even though sources of pressurized air 26 disclosed above (e.g. passenger cabin 38, cabin pressurization system 40, compressor 14 and bypass duct 44) are presented as alternatives, any one or more of these and/or other sources of pressurized air may be used, for example in order to provide redundancy in the supply of top-up air to housing 22. For example, conduits 28A, 28D may be provided to allow top-up air to be obtained from cabin pressurization system 40 and/or bypass duct 44. Other combinations of conduits 28A-28D may be used and may be required to provide redundancy. As will be understood by those skilled in the relevant arts, conduits 28A-28D may be sized and routed according to conventional methods known in the art.

In use, a housing 22 provides an enclosure for one or more electrical devices 24. Each of electrical device(s) 24 may comprise any number of electrical/electronic components. Electrical device(s) 24 may comprise at least a portion of a high voltage engine-mounted power system and may require specific environmental conditions for proper operation. Advantageously, since housing(s) 22 are in fluid communication with source(s) 26 of pressurized air or other gas(ses) to provide top-up air if needed, housing(s) 22 may not have to be hermetically sealed. Housing 22 may be designed to allow, for example, for some leakage during some phases of flight of aircraft 36. For example, housing(s) 22 may be designed to withstand any specific required or convenient differential pressures. For example, housing(s) 22 may be designed to leak at a rate great enough to allow maintenance of a differential pressure of about 12 psi (82.7 KPa) with no more than a pre-determined amount of leakage allowed through structural seams, connections, etc.

Any suitable materials may be used for the construction of housing(s) 22 and other components of the systems disclosed herein. As will be understood by those skilled in the relevant arts, the suitability of materials for use in construction of housing(s) 22 will be determined by many factors, including for example anticipated differential pressures to be maintained by the housings; engine, component, and other operating temperatures; gas, oil, combustion, and other contaminants or environmental factors, etc.

Where a housing 22 is expected to leak, top-up air may be provided to housing 22 from source(s) 26 of pressurized air or other gasses to compensate for the leak. The flow of top-up air may maintain environmental conditions inside housing 22 to an acceptable level and also maintain a positive pressure inside housing 22 in relation to the environment outside of housing 22.

When gas(ses) are supplied using the passenger cabin environment (either from passenger cabin 38 or cabin pressurization system 40), housing(s) 22 may not require monitoring equipment since the top-up air from the cabin environment may already be in a suitable condition for entering housing(s) 22. However, one or more check valves may be used as flow control device(s) 32 to allow one-way flow of top-up air to housing(s) 22 and prevent any back flow from housing(s) 22 into passenger cabin 38 or cabin pressurization system 40. Flow control device(s) 32 may also allow for pressure inside housing(s) 22 to be substantially the same as pressure inside passenger cabin 38.

Where necessary or desired, monitoring equipment may be used to detect the fact and optionally the amount of leakage from a housing 22, and accordingly to provide an indication, and/or any suitable cockpit or other control warnings, that additional top-up gas and/or maintenance is required. In such case continuous operation of aircraft 36 while top-up air is being supplied to housing 22 may not be desirable in the long term and the repair of any leaks in housing 22 may be preferable. For example, one or more pressure transducers (not shown) may be used to detect when pressure inside housing 22 has dropped below an acceptable threshold and cause input power to electrical device 24 to be interrupted. The interruption of input power may be temporary until pressure inside housing 22 is restored to an acceptable level, for example, via conduit(s) 28.

Among other advantages, housing assembly(ies) 20 significantly reduce the potential for corona discharge and arcing in electrical device(s) 24 due to variations in environmental conditions. The use of housing assembly(ies) 20 permits electrical buswork to be more compact and excessive spacing between conductors typically required to prevent corona discharge problems is not required. In addition, housing assembly(ies) 20 provide failure mitigation in the event where leakage would occur in a sealed housing.

The above description is meant to be exemplary only. Those skilled in the relevant arts will recognize that changes may be made to the embodiments described without departing from the scope of the invention disclosed. For example, housing(s) 22 may be installed in portions of aircraft that are external to the passenger cabin other than on or near an engine. Still other modifications which fall within the scope of the present invention will be apparent to those skilled in the art, in light of a review of this disclosure, and such modifications are intended to fall within the appended claims.

What is claimed is:

1. A housing assembly for an electrical device for use on an aircraft, the assembly comprising:
a housing configured for containing at least one electrical component in a portion of the aircraft vented to atmosphere; and
a pressure communication line for communicating between an interior of the housing and a source of pressurized gas available on the aircraft for other primary purpose.

2. The assembly of claim 1, wherein the housing is configured for mounting on an engine of the aircraft.

3. The assembly of claim 3, wherein the source of pressurized gas comprises a cabin pressurization system of the aircraft.

4. The assembly of claim 1, wherein the source of pressurized gas comprises a cabin pressurization system of the aircraft.

5. The assembly of claim 1, comprising a desiccant.

6. The assembly of claim 1, comprising a flow control device allowing one-way flow of top-up gas to the housing.

7. The assembly of claim 1, wherein the pressure communication line communicates with a passenger cabin of the aircraft.

8. The assembly of claim 1, wherein the source of pressurized gas comprises a bypass duct of a gas turbine.

9. The assembly of claim 1, wherein the source of pressurized gas comprises a compressor of a gas turbine engine.

10. A gas turbine engine assembly for use on an aircraft comprising:
a gas turbine engine;
a housing mounted on the gas turbine engine and configured for containing at least one component of an electrical system of the engine; and
a pressure communication line for communicating between an interior of the housing and a source of pressurized gas available on the aircraft for other primary purpose.

11. The assembly of claim 10, wherein the source of pressurized gas comprises a bypass duct of the gas turbine engine.

12. The assembly of claim 10, wherein the source of pressurized gas comprises a passenger cabin of the aircraft.

13. The assembly of claim 10, wherein the source of pressurized gas comprises a compressor of the gas turbine engine.

14. The assembly of claim 10, wherein the source of pressurized gas comprises a cabin pressurization system of the aircraft.

15. The assembly of claim 14, comprising a desiccator.

16. The assembly of claim 14, comprising a desiccant substance.

17. The assembly of claim 14, comprising a flow control device allowing one-way flow of top-up air to the housing.

18. A method for maintaining an environment inside a housing for an electrical device, the housing being located in a portion of an aircraft vented to atmosphere, the method comprising:
providing the housing with a flow of top-up air from a source of pressurized air available on the aircraft for other primary purpose.

19. The method as defined in claim 18 comprising removing moisture from the top-up air.

20. The method as defined in claim 18 comprising maintaining a pressure inside the housing substantially the same as a pressure of the source of pressurized air.

21. A housing assembly for an electrical device for use on an aircraft, the assembly comprising:
a housing configured for containing at least one electrical component in a portion of the aircraft vented to atmosphere; and
means for communicating between an interior of the housing and a source of pressurized gas available on the aircraft for other primary purpose.
